(19) United States
(12) Patent Application Publication
(10) Pub. No.: US 2025/0038801 A1
(43) Pub. Date: Jan. 30, 2025

(54) METHOD AND APPARATUS FOR TRANSMITTING INFORMATION, TERMINAL, AND NETWORK SIDE DEVICE

(71) Applicant: VIVO MOBILE COMMUNICATION CO., LTD., Dongguan (CN)

(72) Inventors: Bule SUN, Dongguan (CN); Hao LIU, Dongguan (CN)

(73) Assignee: VIVO MOBILE COMMUNICATION CO., LTD., Dongguan (CN)

(21) Appl. No.: 18/912,562

(22) Filed: Oct. 10, 2024

Related U.S. Application Data
(63) Continuation of application No. PCT/CN2023/087616, filed on Apr. 11, 2023.

(30) Foreign Application Priority Data
Apr. 11, 2022 (CN) 202210376061.2

(51) Int. Cl. H04B 7/0456

(52) U.S. Cl. CPC H04B 7/0473

(57) ABSTRACT

This application discloses methods for transmitting information, a terminal, and a network side device. The method for transmitting information includes: transmitting, by a second device, a first signal to a first device. The first signal is generated precoding a signal mapped on N sub-blocks of a first signal domain corresponding to the sub-blocks, and then transforming the precoded signal into a time-frequency domain. The first signal domain is a delay-Doppler domain, the first signal domain is divided into the N sub-blocks, and N is a positive integer greater than or equal to 2.

### CROSS-REFERENCE TO RELATED APPLICATIONS

The disclosure is a continuation of International Application No. PCT/CN 2023/087616, filed on Apr. 11, 2023, which claims the priority to Chinese Patent Application No. 202210376061.2, filed with the Chinese Patent Office on Apr. 11, 2022. The entire contents of each of the above-referenced applications are expressly incorporated herein by reference.

### TECHNICAL FIELD

The disclosure belongs to the technical field of mobile communication, and in particular to a method and apparatus for transmitting information, a terminal, and a network side device.

### BACKGROUND

At a transmitter, a delay-Doppler domain is divided into multiple sub-regions, and different precoding is applied to different sub-regions. At a receiver, precoding or modulation and coding performance of the transmitter can be evaluated, and corresponding information can be fed back, so as to make a recommendation and adjustment for precoding or modulation and coding methods of the transmitter. Therefore, performance of subsequent downlink transmission is improved.

An Orthogonal Time Frequency Space (OTFS) logically maps information in a data packet of size M×N to a M×N grid point on a two-dimensional delay-Doppler plane. In other words, pulses in each grid point modulate one symbol in the data packet.

In a process of OTFS multi-antenna transmission, space-domain precoding is performed on the delay-Doppler domain collectively through multi-antenna precoding, leading to a mismatch between space-domain precoding performed on the delay-Doppler domain collectively and an actual channel.

### SUMMARY

A method and apparatus for transmitting information, a terminal, and a network side device are provided in embodiments of the disclosure.

In a first aspect, a method for transmitting information is provided. The method is applied to a first device and includes:
receiving, by the first device, a first signal from a second device, where the first signal is acquired after a signal mapped on N sub-blocks of a first signal domain undergoes precoding corresponding to the sub-blocks, and then a precoded signal is transformed into a time-frequency domain; and
the first signal domain is a delay-Doppler domain, the first signal domain is divided into the N sub-blocks, and N is a positive integer greater than or equal to 2.

In a second aspect, an apparatus for transmitting information is provided. The apparatus includes:
a transceiving module configured to receive a first signal from a second device, where the first signal is acquired after a signal mapped on N sub-blocks of a first signal domain undergoes precoding corresponding to the sub-blocks, and then a precoded signal is transformed into a time-frequency domain; and
a parsing module configured to parse the first signal; where
the first signal domain is a delay-Doppler domain, the first signal domain is divided into the N sub-blocks, and N is a positive integer greater than or equal to 2.

In a third aspect, a method for transmitting information is provided. The method is applied to a second device and includes:
transmitting, by the second device, a first signal to a first device, where the first signal is acquired after a signal mapped on N sub-blocks of a first signal domain undergoes precoding corresponding to the sub-blocks, and then a precoded signal is transformed into a time-frequency domain; and
the first signal domain is a delay-Doppler domain, the first signal domain is divided into the N sub-blocks, and N is a positive integer greater than or equal to 2.

In a fourth aspect, an apparatus for transmitting information is provided. The apparatus includes:
a determination module configured to determine a first signal; and
a transmission module configured to transmit the first signal to a first device, where the first signal is acquired after a signal mapped on N sub-blocks of a first signal domain undergoes precoding corresponding to the sub-blocks, and then a precoded signal is transformed into a time-frequency domain; and
the first signal domain is a delay-Doppler domain, the first signal domain is divided into the N sub-blocks, and N is a positive integer greater than or equal to 2.

In a fifth aspect, a terminal is provided. The terminal includes a processor and a memory, where the memory stores a program or instruction runnable on the processor, and when executed by the processor, the program or instruction implements steps of the method in the first aspect or steps of the method in the third aspect.

In a sixth aspect, a network side device is provided. The network side device includes a processor and a memory, where the memory stores a program or instruction runnable on the processor, and when executed by the processor, the program or instruction implements steps of the method in the first aspect or steps of the method in the third aspect.

In a seventh aspect, a system for transmitting information is provided. The system includes: a terminal and a network side device, where the terminal may be configured to execute steps of the method for transmitting information in the first aspect or the third aspect, and the network side device may be configured to execute steps of the method for transmitting information in the first aspect or the third aspect.

In an eighth aspect, a readable storage medium is provided. The readable storage medium stores a program or instruction, where when executed by a processor, the program or instruction implements steps of the method in the first aspect or steps of the method in the third aspect.

In a ninth aspect, a chip is provided. The chip includes a processor and a communication interface, where the communication interface is coupled to the processor, and the processor is configured to run a program or instruction, so as to implement the method in the first aspect or the method in the third aspect.

In a tenth aspect, a computer program/program product is provided. The computer program/program product is stored in a storage medium, and the computer program/program product is executed by at least one processor, so as to implement steps of the method for transmitting information in the first aspect or steps of the method for transmitting information in the third aspect.

In the embodiments of the disclosure, the delay-Doppler domain is divided into the N sub-blocks, and precoding is performed on each sub-block with a corresponding codeword. Then, the first signal is transmitted after OTFS modulation is performed, so that a more desirable match between the precoding and an actual channel is realized.

### BRIEF DESCRIPTION OF THE DRAWINGS

FIG. 1 is a schematic structural diagram of a radio communication system applicable to an embodiment of the disclosure;

FIG. 2 is a schematic flowchart of a method for transmitting information according to an embodiment of the disclosure;

FIG. 3 is a schematic diagram of a resource of a delay-Doppler domain according to an embodiment of the disclosure;

FIG. 4 is a schematic flowchart of a method for transmitting information according to an embodiment of the disclosure;

FIG. 5 is another schematic flowchart of a method for transmitting information according to an embodiment of the disclosure;

FIG. 6 is another schematic diagram of a resource of a delay-Doppler domain according to an embodiment of the disclosure;

FIG. 7 is a schematic flowchart of a method for receiving information according to an embodiment of the disclosure;

FIG. 8 is yet another schematic diagram of a resource of a delay-Doppler domain according to an embodiment of the disclosure;

FIG. 9 is another schematic flowchart of a method for receiving information according to an embodiment of the disclosure;

FIG. 10 is a schematic structural diagram of an apparatus for transmitting information according to an embodiment of the disclosure;

FIG. 11 is yet another schematic flowchart of a method for transmitting information according to an embodiment of the disclosure;

FIG. 12 is another schematic structural diagram of an apparatus for transmitting information according to an embodiment of the disclosure;

FIG. 13 is a schematic structural diagram of a communication device according to an embodiment of the disclosure;

FIG. 14 is a schematic structural diagram of a terminal according to an embodiment of the disclosure;

FIG. 15 is a schematic structural diagram of another terminal according to an embodiment of the disclosure; and

FIG. 16 is a schematic structural diagram of a network side device according to an embodiment of the disclosure.

### DETAILED DESCRIPTION

The technical solutions in embodiments of the disclosure are clearly described below with reference to the accompanying drawings in the embodiments of the disclosure. Apparently, the embodiments described are merely some embodiments rather than all embodiments of the disclosure. All other embodiments derived by those of ordinary skill in the art based on the embodiments of the disclosure fall within the scope of protection of the disclosure.

The terms “first”, “second”, etc. in the description and claims of the disclosure are used to distinguish between similar objects, instead of describing a specific sequence or a successive order. It should be understood that the terms used in this way are interchangeable where appropriate, so that the embodiments of the disclosure can be implemented in an order different from the order shown or described herein. Moreover, the objects distinguished by “first” and “second” are usually of one type, and a number of objects is not limited. For example, a first object can indicate one or more objects. In addition, “and/or” in the description and claims indicates at least one of objects connected. The character “/” generally indicates that objects associated are in an “or” relationship.

It should be noted that the technologies described in the embodiments of the disclosure are not limited to a Long Term Evolution (LTE)/LTE-Advanced (LTE-A) system, and can also be used for other radio communication systems, such as Code Division Multiple Access (CDMA), Time Division Multiple Access (TDMA), Frequency Division Multiple Access (FDMA), Orthogonal Frequency Division Multiple Access (OFDMA), and Single-carrier Frequency Division Multiple Access (SC-FDMA). The terms “system” and “network” in the embodiments of the disclosure are often used interchangeably. The technologies described can be applied to the systems and radio technologies mentioned above, and can also be applied to other systems and radio technologies. The following descriptions illustratively describe a new radio (New Radio, NR) system, and the NR terms are used in most of the following descriptions. However, these technologies can also be applied to applications except for an application in the NR system, such as a 6th Generation (6G) communication system.

FIG. 1 is a block diagram of a radio communication system applicable to an embodiment of the disclosure. The radio communication system includes a terminal 11 and a network side device 12. The terminal 11 can be a mobile phone, a tablet personal computer, a laptop computer (also referred to as a notebook computer), a Personal Digital Assistant (PDA), a palmtop computer, a netbook, an Ultra-Mobile Personal Computer (UMPC), a Mobile Internet Device (MID), an Augmented Reality (AR)/Virtual Reality (VR) device, a robot, a wearable device, Vehicle User Equipment (VUE), Pedestrian User Equipment (PUE), a smart home (a home device having a radio communication function, such as a refrigerator, a television, a washing machine, and furniture), a game console, a Personal Computer (PC), a teller machine, a self-service machine, etc. The wearable device includes: a smart watch, a smart band, a smart headphone, smart glasses, smart jewelry (a smart wristlet, a smart hand chain, a smart ring, a smart necklace, a smart anklet, a smart ankle chain, etc.), a smart wristband, smart clothing, etc. It should be noted that a specific type of the terminal 11 is not limited in the embodiment of the disclosure. The network side device 12 can include an access network device or a core network device. The access network device 12 can also be referred to as a radio access network device, a Radio Access Network (RAN), a radio access network function, or a radio access network unit. The access network device 12 can include a base station, a Wireless Local Area Network (WLAN) access point, a WiFi node, etc. The base station can be referred to as a node B, an evolved Node B (eNB), an access point, a Base Transceiver Station (BTS), a radio base station, a radio transceiver, a Basic Service Set (BSS), an Extended Service Set (ESS), a home node B, a home evolved node B, a Transmitting Receiving Point (TRP), or some other appropriate terms in the art. The base station is not limited to a specific technical vocabulary, as long as the same technical effect is realized. It should be noted that in the embodiment of the disclosure, only the base station in an NR system is described as an example, but a specific type of the base station is not limited. The core network device may include, but is not limited to, at least one of the following: a core network node, a core network function, a Mobility Management Entity (MME), an Access and Mobility Management Function (AMF), a Session Management Function (SMF), a User Plane Function (UPF), a Policy Control Function (PCF), a Policy and Charging Rules Function (PCRF), an Edge Application Server Discovery Function (EASDF), Unified Data Management (UDM), a Unified Data Repository (UDR), a Home Subscriber Server (HSS), a Centralized network configuration (CNC), a Network Repository Function (NRF), a Network Exposure Function (NEF), a Local NEF (or L-NEF), a Binding Support Function (BSF), an Application Function (AF), etc. It should be noted that in the embodiment of the disclosure, only a core network device in the NR system is described as an example, but a specific type of the core network device is not limited.

A method and apparatus for transmitting information, a terminal, and a network side device according to the embodiments of the disclosure are described in detail below with reference to the accompanying drawings through some embodiments and their application scenarios.

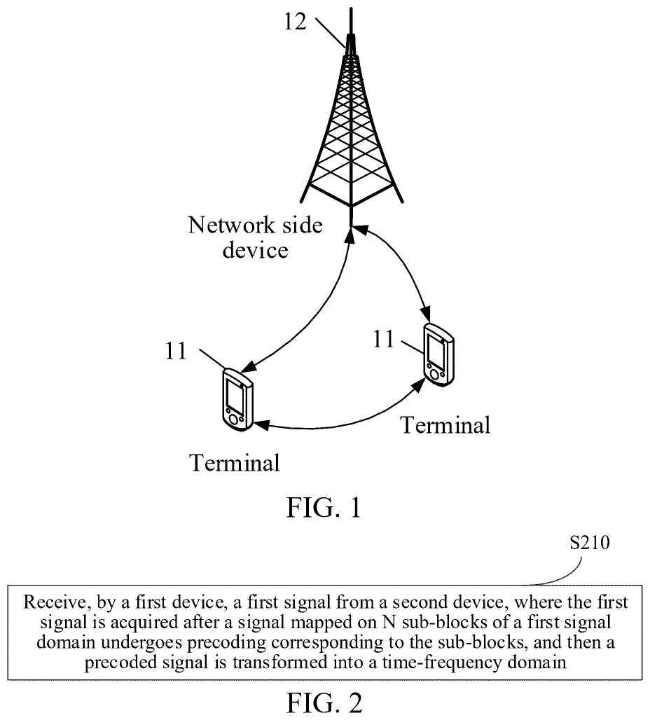

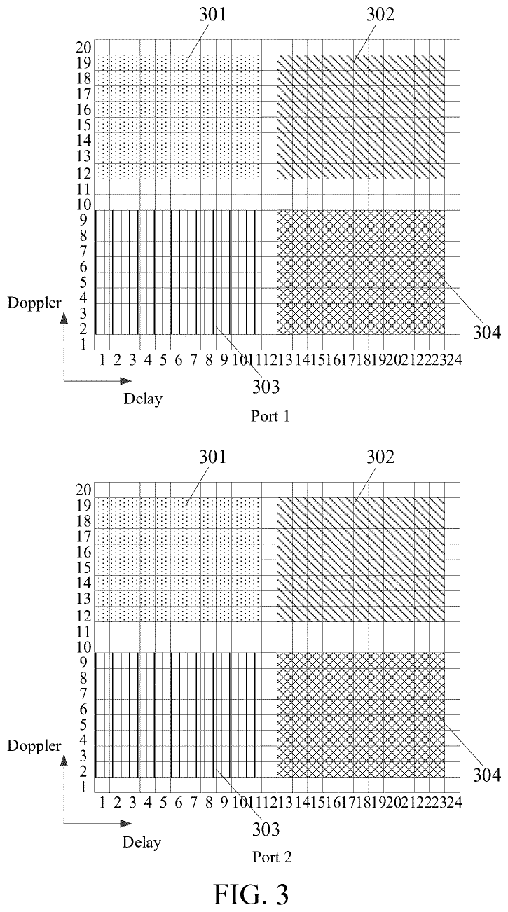

As shown in FIGS. 2 and 3, a method for transmitting information is provided in an embodiment of the disclosure. An execution entity of the method is a first device, and the first device may be a network side device or a terminal. In other words, the method may be executed by software or hardware installed on the first device. The method further includes:
S210, the first device receives a first signal from a second device, where the first signal is acquired after a signal mapped on N sub-blocks of a first signal domain undergoes precoding corresponding to the sub-blocks, and then a precoded signal is transforming into a time-frequency domain; and
the first signal domain is a delay-Doppler domain, the first signal domain is divided into the N sub-blocks, and N is a positive integer greater than or equal to 2.

It should be understood that the first signal may be an OTFS modulated signal, and may also be a signal based on other modulation method, for example, a modulation method based on Walsh-Hadamard Transform (WHT) or Discrete Cosine Transform (DCT).

The second device divides the delay-Doppler domain into the N sub-blocks. For example, as shown in FIG. 3, the delay-Doppler domain is divided into 4 sub-blocks, i.e. a first sub-block 301, a second sub-block 302, a third sub-block 303, and a fourth sub-block 304.

It should be understood that a size for dividing each sub-block may be set as demanded in practice. A number of resource grids occupied by each sub-block may be designed to be the same. As shown in FIG. 3, a number of resource grids occupied by the four sub-blocks is the same. For example, a number of resource grids occupied by each sub-block may also be designed to be different.

Further, in a case of performing OTFS multi-antenna transmission, precoding is performed on all ports on the same sub-block with the same codeword. As shown in FIG. 3, different patterns indicate corresponding codewords respectively. Precoding is performed on the first sub-block 301, the second sub-block 302, the third sub-block 303, and the fourth sub-block 304 with a codeword W1, a code word W2, a code word W3, and a code word W4 respectively. Since the second device transmits the first signal through a port 1 and a port 2, precoding is performed on the same sub-block with the same codeword at the port 1 and the port 2.

Precoding is performed on different sub-blocks with the same or different codewords. As shown in FIG. 3, the codewords W1, W2, W3, and W4 may be partially the same. For example, the codeword W1 and the codeword W3 are the same.

In an implementation, all the ports on the same sub-block have the same number of layers.

In an implementation, a codeword for the precoding is determined through one of the following methods:
stipulation in a protocol;
indication through signaling; and
selection from a codeword set for precoding. The selection may be made randomly or according to stipulation in a protocol or indication through signaling.

In an implementation, first guard intervals are configured between the N sub-blocks in a delay domain direction and a Doppler domain direction. As shown in FIG. 3, the first guard intervals configured between adjacent sub-blocks occupy one grid in the delay domain direction and two grids in the Doppler domain direction.

A size of the first guard interval may be configured as demanded in practice. In an implementation, the first guard intervals between adjacent sub-blocks should not be less than a maximum transmission delay in a current transmission environment in the delay direction, and the first guard intervals between adjacent sub-blocks should not be less than twice maximum transmission Doppler in a current transmission environment in the Doppler direction.

In an implementation, precoding may be performed on different sub-blocks (for example, the first sub-block 301 and the third sub-block 303, or the second sub-block 302 and the fourth sub-block 304 shown in FIG. 3) having the same resource position in a delay domain and distinguished by the first guard intervals in the Doppler domain direction with the same codeword.

In an implementation, precoding may be performed on different sub-blocks (for example, the first sub-block 301 and the second sub-block 302, or the third sub-block 303 and the fourth sub-block 304 shown in FIG. 3) having the same resource position in a Doppler domain and distinguished by the first guard intervals in a delay domain direction with the same codeword.

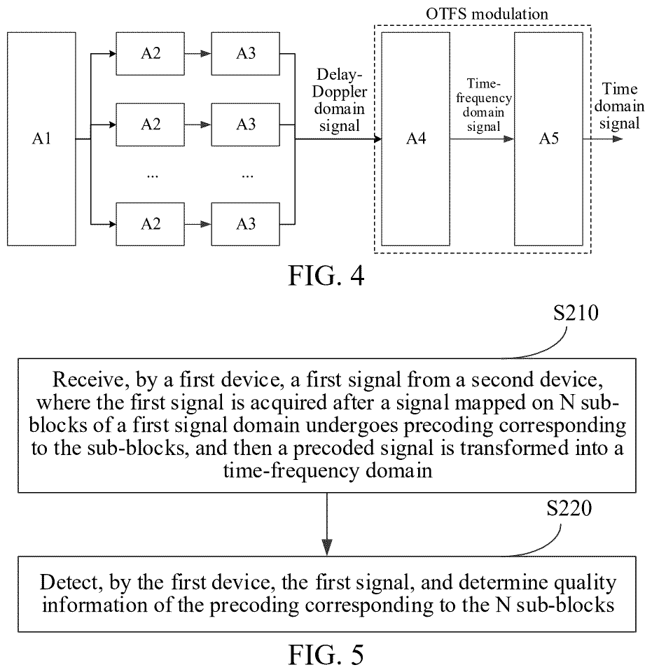

In an embodiment, the flow for the second device to transmit the first signal is shown in FIG. 4, and includes:
A1. The delay-Doppler domain is divided into the N sub-blocks.
A2. Resource mapping is performed on each sub-block of the delay-Doppler domain, where a data signal may be included.
A3. Precoding is performed on each sub-block of the delay-Doppler domain with a codeword corresponding to the sub-block, so as to obtain a delay-Doppler domain signal.
A4. Inverse Symplectic Fourier Transform (ISFFT) is perform on the delay-Doppler domain signal, so as to obtain a time-frequency domain signal.
A5. Heisenberg transform is performed on the time-frequency domain signal, so as to obtain a time domain signal, and the time domain signal is transmitted to the first device.

Steps A4 and A5 are OTFS modulation.

In an implementation, the method further includes:

The first device acquires a sub-block division scheme of the first signal domain.

The sub-block division scheme includes a resource identifier or a set of resource identifiers of the first signal domain.

In an implementation, the sub-block division scheme is acquired through at least one of the following methods:
acquisition from the second device; and
stipulation in a protocol.

It can be seen from the technical solution in the embodiment that in the embodiment of the disclosure, the delay-Doppler domain is divided into the N sub-blocks, and the precoding is performed on each sub-block with the corresponding codeword. Then, the first signal is transmitted after OTFS modulation is performed, so that a more desirable match between the precoding and an actual channel is realized.

Based on the above embodiment, for example, as shown in FIG. 5, after S210, the method further includes:
S220, the first device detects the first signal, and quality information of the precoding corresponding to the N sub-blocks is determined.
S220 may have various implementations. In an implementation, a pilot signal is configured in the first signal, and S220 includes:
the first device determines the pilot signal in the first signal according to pilot configuration information, and acquires first channel information corresponding to the pilot signal; where the first channel information is equivalent channel information acquired based on spatial channel information and precoding information; and the precoding information indicates the codeword for precoding, etc.; and
the first device detects the first signal according to the first channel information, and determines the quality information of the precoding corresponding to the N sub-blocks.

It should be understood that the spatial channel information and the precoding information may be in a form of matrixes. The first channel information may be acquired by multiplying the spatial channel information by the precoding information.

In an implementation, the pilot configuration information may include:
a position of the pilot signal in the first signal domain; and
a position of a second guard interval corresponding to the pilot signal in the first signal domain.

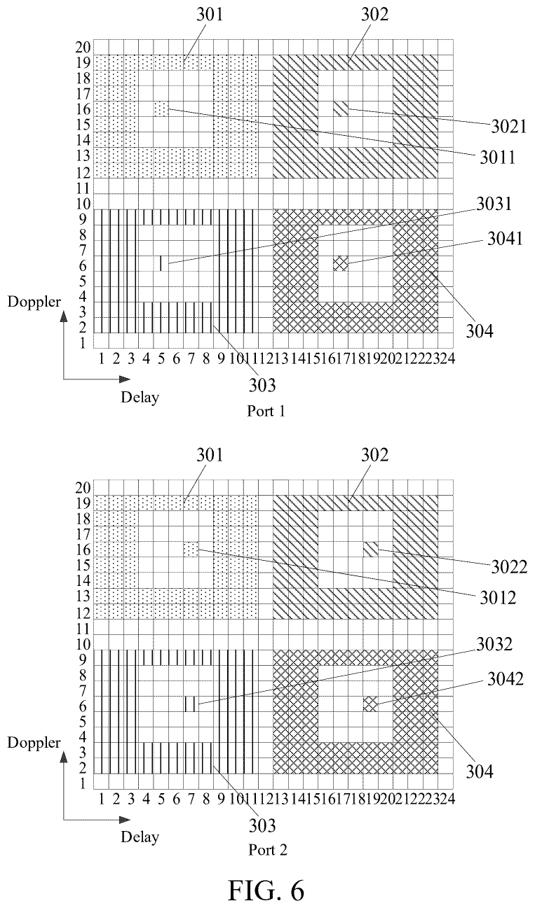

The pilot signal in the first signal may be set as demanded in practice. In an embodiment, since precoding may be performed on different sub-blocks with different codewords, the pilot signal in the first signal may be a first pilot signal positioned in each sub-block. In other words, resource mapping performed on each sub-block of the delay-Doppler domain may include the data signal and the first corresponding pilot signal. Since the first pilot signal in each sub-block and the data signal on the sub-block employ the same precoding, a channel estimated based on the first pilot signal in each sub-block is consistent with a channel experienced by the data signal, and may be directly configured for detection or demodulation. As shown in FIG. 6, for the port 1, a first pilot signal 3011 is configured in the first sub-block 301, a first pilot signal 3021 is configured in the second sub-block 302, a first pilot signal 3031 is configured in the third sub-block 303, and a first pilot signal 3041 is configured in the fourth sub-block 304. For the port 2, a first pilot signal 3012 is configured in the first sub-block 301, a first pilot signal 3022 is configured in the second sub-block 302, a first pilot signal 3032 is configured in the third sub-block 303, and a first pilot signal 3042 is configured in the fourth sub-block 304. The position of the pilot signal may be different for different ports.

For the first pilot signal, the first device determines a position of the first pilot signal in each sub-block in the first signal and a position of a second guard interval corresponding to the first pilot signal according to the pilot configuration information; and
first channel information of each sub-block, i.e. equivalent channel information of each sub-block is acquired according to the position of the first pilot signal in each sub-block and the position of the second guard interval corresponding to the first pilot signal.

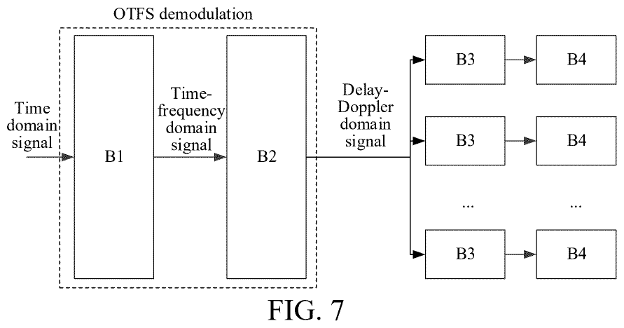

In an implementation, the flow for the first device to receive the first signal is shown in FIG. 7, and includes:
B1. Wigner transform is performed on the time domain signal received, so as to obtain a time-frequency domain signal.
B2. Symplectic Fourier transform is performed on the time-frequency domain signal, so as to obtain a delay-Doppler domain signal.
B3. A channel is estimated based on the first pilot signal in each sub-block of the delay-Doppler domain, so as to obtain first channel information corresponding to each sub-block.
B4. The data signal in each sub-block of the delay-Doppler domain is detected and/or demodulated according to the first channel information.

Steps B1 and B2 are OTFS modulation.

In an implementation, before S220, the method further includes:

The first device acquires pilot configuration information, i.e. a position of a first pilot signal in each sub-block and a position of a second guard interval corresponding to the first pilot signal.

In an implementation, the pilot configuration information may be received from the second device or stipulated in a protocol.

In an implementation, after S220, the method further includes:

The first device feeds back feedback information of precoding corresponding to a target sub-block to the second device, where the target sub-block is all or some sub-blocks of the N sub-blocks, and may be, for example, sub-blocks having an undesirable quality of precoding not satisfying requirements.

In an implementation, the feedback information includes at least one of the following:
a quality of the precoding corresponding to the target sub-block;
a codeword for precoding recommended for the target sub-block; and
a Modulation and Coding Scheme (MCS) recommended for the target sub-block.

After receiving the feedback information, the first device may dynamically adjust the precoding corresponding to each sub-block, for example, through the codeword recommended in the feedback information or the modulation and coding scheme recommended in the feedback information.

In such a technical solution, the precoding of each sub-block may be changed dynamically, and the codeword for precoding each sub-block is transparent to the first device.

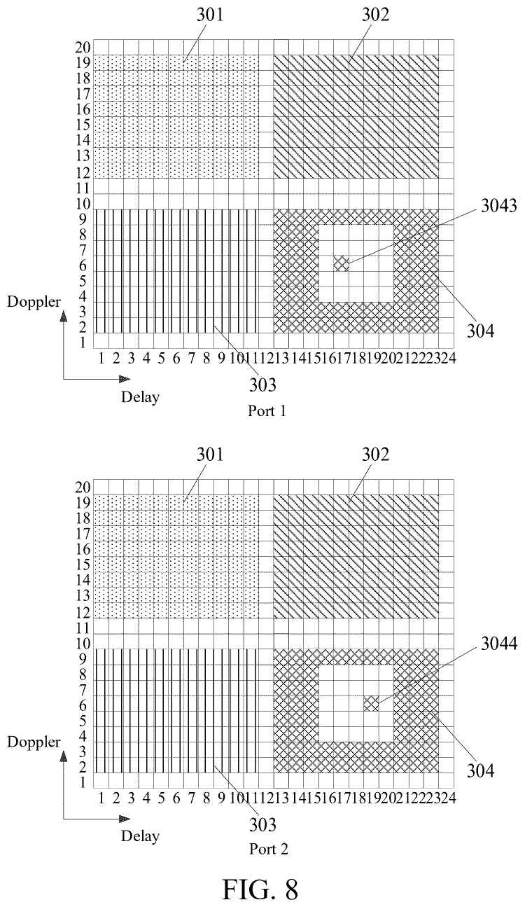

In another implementation, the pilot signal in the first signal may be a second pilot signal positioned in one sub-block, where the second pilot signal is a common pilot signal. As shown in FIG. 8, for the port 1, a second pilot signal 3043 is configured on the fourth sub-block 304. For the port 2, and a second pilot signal 3044 is configured on the fourth sub-block 304. The position of the pilot signal may be different for different ports.

In an implementation, for the second pilot signal, the first device determines a position of the second pilot signal in the first signal and a position of a second guard interval corresponding to the second pilot signal according to the pilot configuration information; and
first channel information corresponding to the second pilot signal is acquired according to the position of the second pilot signal and the position of the second guard interval corresponding to the second pilot signal.

Further, the step that first channel information corresponding to the second pilot signal is acquired according to the position of the second pilot signal and the position of the second guard interval corresponding to the second pilot signal includes:
first channel information of a sub-block in which the second pilot signal is positioned, i.e. equivalent channel information of a sub-block in which the second pilot signal is position is acquired according to the position of the second pilot signal and the position of the second guard interval corresponding to the second pilot signal; and
second channel information corresponding to the second pilot signal is acquired according to the first channel information of the sub-block in which the second pilot signal is positioned and the precoding information; where the second channel information is spatial channel information; and since a spatial channel experienced by each sub-block is the same, the second channel information corresponding to the second pilot signal may be taken as the second channel information corresponding to each sub-block; and
first channel information of each sub-block is acquired according to precoding information and the second channel information of each sub-block.

In an implementation, a fixed codeword configured for the common pilot signal may be configured for precoding the sub-block in which the second pilot signal is positioned, where the codeword may be stipulated in a protocol.

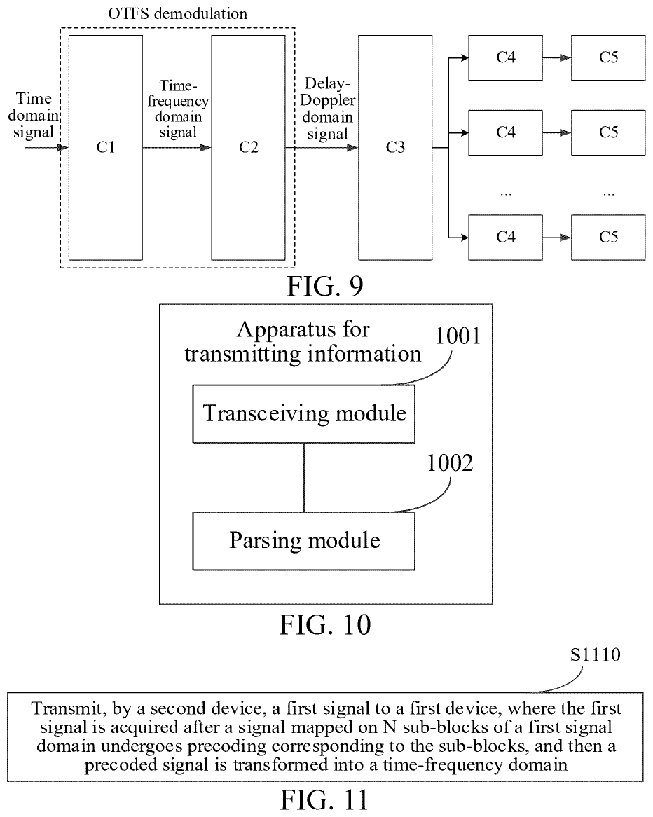

In an implementation, the flow for the first device to receive the first signal is shown in FIG. 9, and includes:
C1. Wigner transform is performed on the time domain signal received, so as to obtain a time-frequency domain signal.
C2. Symplectic Fourier transform is performed on the time-frequency domain signal, so as to obtain a delay-Doppler domain signal.
C3. A channel is estimated based on the second pilot signal in the delay-Doppler domain, so as to obtain second channel information corresponding to the second pilot signal.
C4. First channel information of each sub-block is acquired based on precoding information and the second channel information of each sub-block in the delay-Doppler domain.
C5. The data signal in each sub-block of the delay-Doppler domain is detected and/or demodulated according to the first channel information.

Steps C1 and C2 are OTFS modulation.

In an implementation, before S220, the method further includes:

The first device acquires the pilot configuration information and precoding information corresponding to each sub-block, where the pilot configuration information includes a position of the second pilot signal and a position of a second guard interval corresponding to the second pilot signal.

In an implementation, the pilot configuration information and the precoding information corresponding to each sub-block may be received from the second device or stipulated in a protocol.

In an implementation, after S220, the method further includes:

The first device feeds back feedback information of precoding corresponding to a target sub-block to the second device, where the target sub-block is all or some sub-blocks of the N sub-blocks.

In an implementation, the feedback information includes at least one of the following:
a quality of the precoding corresponding to the target sub-block;
a codeword for precoding recommended for the target sub-block; and
an MCS recommended for the target sub-block.

After receiving the feedback information, the second device may dynamically adjust precoding corresponding to sub-blocks other than the sub-block in which the second pilot signal is positioned.

Compared with the solution that the first pilot signal is configured in each sub-block, in such a technical solution, pilot overhead can be reduced.

In an implementation, the method further includes:

The first device acquires a pilot configuration scheme of the first signal, where the pilot configuration scheme may include which pilot configuration method is employed, for example, whether the first pilot signal or the second pilot signal is employed, and may further include pilot configuration information corresponding to the pilot signal, a symbol of the pilot signal, etc.

In an implementation, the pilot configuration scheme is acquired through at least one of the following methods:
acquisition from the second device; and
stipulation in a protocol.

In an implementation, in a case that multiple antenna ports employ delay diversity transmission and/or Doppler diversity transmission, timing offset and/or frequency offset of the first device and a pilot signal corresponding to one antenna port have a Quasi Co-Location (QCL).

In an implementation, the quasi co-location is configured through at least one of the following methods:
indication through signaling; and
stipulation in a protocol.

It can be seen from the technical solution in the above embodiment that in the embodiment of the disclosure, the pilot signal is configured in the first signal, so that the first device may detect the first signal based on estimation through the pilot signal, and determine the quality information of the precoding corresponding to each sub-block. Therefore, the precoding of each sub-block may be dynamically adjusted through the feedback information, so that a more desirable match between the precoding and the actual channel is realized.

Channel prediction is an important function of a 5th-Generation Mobile Communication (5G) technology and 6G in the future. Conventional channel feedback information primarily includes a feedback channel itself, for example, a type 2 (type II); and feeds back a precoding codebook matching the channel, for example, a type 1 (type I). The channel prediction based on the above channel feedback information generally has undesirable performance because there is no accurate delay and Doppler values in the channel feedback.

Based on the above embodiment, for example, in a case that first channel information corresponding to the pilot signal is acquired, the method further includes:

The first device transmits first information to the second device, where the first information includes channel information of a channel between the first device and the second device. The channel information may include the first channel information or the second channel information in the above embodiment, or may be channel information in other forms.

Further, the channel information includes at least one of the following:
Doppler information of the channel; and
delay information of the channel.

Further, the Doppler information of the channel includes at least one of the following:
all Doppler values of the channel; and
a Doppler maximum, a Doppler minimum, or a Doppler average of the channel.

The above Doppler information may include original values of the above Doppler values, or may be results obtained by transforming the above Doppler values, for example, performing quantization coding, grading, or magnitude relationship comparison with Doppler values fed back last time.

Further, the delay information of the channel includes at least one of the following:
all delay values of the channel; and
a delay maximum, a delay minimum, or a delay average of the channel.

The above delay information may include original values of the above delay values, or may be results obtained by transforming the above delay values, for example, performing quantization coding, grading, or magnitude relationship comparison with delay values fed back last time.

The technical solution in the embodiment of the disclosure may also be applied to other application scenarios. After estimating the channel between the first device and the second device, the first device may feed back the first information to the second device.

It can be seen from the technical solution in the above embodiment that in the embodiment of the disclosure, the delay values or a delay range, and the Doppler values or a Doppler range of the channel are directly described by newly defining various feedback quantities of the delay-Doppler domain in the first information fed back. Since the delay and Doppler of the channel encompass a law of channel transformation with time and a law of channel change with frequency, channel prediction may be better performed based on the feedback quantity newly added.

In the method for transmitting information according to the embodiment of the disclosure, an execution entity may be an apparatus for transmitting information. In the embodiment of the disclosure, the apparatus for transmitting information according to the embodiment of the disclosure is described with the apparatus for transmitting information executing the method for transmitting information as an example.

As shown in FIG. 10, the apparatus for transmitting information includes: a transceiving module 1001 and a parsing module 1002.

The transceiving module 1001 is configured to receive a first signal from a second device, where the first signal is acquired after a signal mapped on N sub-blocks of a first signal domain undergoes precoding corresponding to the sub-blocks, and then a precoded signal is transformed into a time-frequency domain; and the parsing module 1002 is configured to parse the first signal; where the first signal domain is a delay-Doppler domain, the first signal domain is divided into the N sub-blocks, and N is a positive integer greater than or equal to 2.

Further, all ports on the same sub-block have the same number of layers.

Further, precoding is performed on all ports on the same sub-block with the same codeword.

Further, a codeword for the precoding is determined through one of the following methods:
stipulation in a protocol;
indication through signaling; and
selection from a codeword set for precoding.

Further, first guard intervals are configured between the N sub-blocks in a delay domain direction and a Doppler domain direction.

Further, precoding is performed on different sub-blocks having the same resource position in a delay domain and distinguished by first guard intervals in the Doppler domain direction with the same codeword.

Further, precoding is performed on different sub-blocks having the same resource position in a Doppler domain and distinguished by first guard intervals in the delay domain direction with the same codeword.

Further, the transceiving module 1001 is further configured to acquire a sub-block division scheme of the first signal domain.

Further, the sub-block division scheme includes a resource identifier or a set of resource identifiers of the first signal domain.

Further, the sub-block division scheme is acquired through at least one of the following methods:
acquisition from the second device; and
stipulation in a protocol.

It can be seen from the technical solution in the embodiment that in the embodiment of the disclosure, the delay-Doppler domain is divided into the N sub-blocks, and the precoding is performed on each sub-block with the corresponding codeword. Then, the first signal is transmitted after OTFS modulation is performed, so that a more desirable match between the precoding and an actual channel is realized.

Based on the above embodiment, for example, the parsing module 1002 is further configured to detect the first signal, and determine quality information of the precoding corresponding to the N sub-blocks.

Further, the parsing module 1002 is configured to:
determine a pilot signal in the first signal according to pilot configuration information, and acquire first channel information corresponding to the pilot signal; where the first channel information is equivalent channel information acquired based on spatial channel information and precoding information; and
the first device detects the first signal according to the first channel information, and determines the quality information of the precoding corresponding to the N sub-blocks.

Further, the pilot signal in the first signal is at least one of the following:
a first pilot signal positioned in each sub-block; and
a second pilot signal positioned in one sub-block, where the second pilot signal is a common pilot signal.

Further, for the first pilot signal, the parsing module 1002 is configured to:
determine a position of the first pilot signal in each sub-block in the first signal and a position of a second guard interval corresponding to the first pilot signal according to the pilot configuration information; and
acquire first channel information of each sub-block according to the position of the first pilot signal in each sub-block and the position of the second guard interval corresponding to the first pilot signal.

Further, for the second pilot signal, the parsing module 1002 is configured to:
determine a position of the second pilot signal in the first signal and a position of a second guard interval corresponding to the second pilot signal according to the pilot configuration information; and
acquire first channel information corresponding to the second pilot signal according to the position of the second pilot signal and the position of the second guard interval corresponding to the second pilot signal.

Further, the parsing module 1002 is configured to:
acquire first channel information of a sub-block in which the second pilot signal is positioned according to the position of the second pilot signal and the position of the second guard interval corresponding to the second pilot signal;
acquire second channel information corresponding to the second pilot signal according to the first channel information of the sub-block in which the second pilot signal is positioned and the precoding information; where the second channel information is spatial channel information; and
acquire first channel information of each sub-block according to precoding information and the second channel information of each sub-block.

Further, the pilot configuration information includes:
a position of the pilot signal in the first signal domain; and
a position of a second guard interval corresponding to the pilot signal in the first signal domain.

Further, the transceiving module 1001 is further configured to acquire at least one of the following information:
pilot configuration information; and
precoding information corresponding to each sub-block.

Further, the pilot configuration information and/or the precoding information corresponding to each sub-block are/is acquired through at least one of the following methods:
acquisition from the second device; and
stipulation in a protocol.

Further, the transceiving module 1001 is further configured to feed back feedback information of precoding corresponding to a target sub-block to the second device, where the target sub-block is all or some sub-blocks of the N sub-blocks.

Further, the feedback information includes at least one of the following:
a quality of the precoding corresponding to the target sub-block;
a codeword for precoding recommended for the target sub-block; and
an MCS recommended for the target sub-block.

Further, the transceiving module 1001 is further configured to acquire a pilot configuration scheme of the first signal.

Further, the pilot configuration scheme is acquired through at least one of the following methods:
acquisition from the second device; and
stipulation in a protocol.

Further, in a case that multiple antenna ports employ delay diversity transmission and/or Doppler diversity transmission, timing offset and/or frequency offset of the first device and a pilot signal corresponding to one antenna port have a quasi co-location.

Further, the quasi co-location is configured through at least one of the following methods:
indication through signaling; and
stipulation in a protocol.

It can be seen from the technical solution in the above embodiment that in the embodiment of the disclosure, the pilot signal is configured in the first signal, so that the first device may detect the first signal based on estimation through the pilot signal, and determine the quality information of the precoding corresponding to each sub-block. Therefore, the precoding of each sub-block may be dynamically adjusted through the feedback information, so that a more desirable match between the precoding and the actual channel is realized.

Based on the above embodiment, for example, the transceiving module 1001 is further configured to transmit first information to the second device, where the first information includes channel information of a channel between the first device and the second device.

Further, the channel information includes at least one of the following:
Doppler information of the channel; and
delay information of the channel.

Further, the Doppler information of the channel includes at least one of the following:
all Doppler values of the channel; and
a Doppler maximum, a Doppler minimum, or a Doppler average of the channel.

Further, the delay information of the channel includes at least one of the following:
all delay values of the channel; and
a delay maximum, a delay minimum, or a delay average of the channel.

It can be seen from the technical solution in the above embodiment that in the embodiment of the disclosure, the delay values or a delay range, and the Doppler values or a Doppler range of the channel are directly described by newly defining various feedback quantities of the delay-Doppler domain in the first information fed back. Since the delay and Doppler of the channel encompass a law of channel transformation with time and a law of channel change with frequency, channel prediction may be better performed based on the feedback quantity newly added.

The apparatus for transmitting information in the embodiment of the disclosure may be an electronic device, for example, an electronic device having an operating system, or a component in an electronic device, for example, an integrated circuit or a chip. The electronic device may be a terminal or another device except for the terminal. Illustratively, the terminal may be of, but is not limited to, a type of the terminal 11 listed above. Another device may be a server, a Network Attached Storage (NAS), etc., which is not specifically limited in the embodiment of the disclosure.

The apparatus for transmitting information according to the embodiment of the disclosure may implement all processes implemented in the method embodiment in FIGS. 2-9, and produces the same technical effects, which will not be described in detail herein to avoid repetition.

As shown in FIG. 11, a method for transmitting information is provided in an embodiment of the disclosure. An execution entity of the method is a second device, and the second device may be a network side device or a terminal.

S1110, the second device transmits a first signal to a first device, where the first signal is acquired after a signal mapped on N sub-blocks of a first signal domain undergoes precoding corresponding to the sub-blocks, and then a precoded signal is transformed into a time-frequency domain; and
the first signal domain is a delay-Doppler domain, the first signal domain is divided into the N sub-blocks, and N is a positive integer greater than or equal to 2.

Further, all ports on the same sub-block have the same number of layers.

Further, precoding is performed on all ports on the same sub-block with the same codeword.

Further, a codeword for the precoding is determined through one of the following methods:
stipulation in a protocol;
indication through signaling; and
selection from a codeword set for precoding.

Further, first guard intervals are configured between the N sub-blocks in a delay domain direction and a Doppler domain direction.

Further, precoding is performed on different sub-blocks having the same resource position in a delay domain and distinguished by first guard intervals in the Doppler domain direction with the same codeword.

Further, precoding is performed on different sub-blocks having the same resource position in a Doppler domain and distinguished by first guard intervals in the delay domain direction with the same codeword.

Further, the method further includes:
the second device transmits a sub-block division scheme of the first signal domain to the first device.

Further, the sub-block division scheme includes a resource identifier or a set of resource identifiers of the first signal domain.

S1110 may implement the method embodiment in FIGS. 2-4, and realize the same technical effects, the repetition of which will not be described in detail herein.

It can be seen from the technical solution in the embodiment that in the embodiment of the disclosure, the delay-Doppler domain is divided into the N sub-blocks, and the precoding is performed on each sub-block with the corresponding codeword. Then, the first signal is transmitted after OTFS modulation is performed, so that a more desirable match between the precoding and an actual channel is realized.

Based on the above embodiment, for example, pilot signals are configured in at least some of the N sub-blocks of the first signal domain.

Further, the pilot signal in the first signal is at least one of the following:
a first pilot signal positioned in each sub-block; and
a second pilot signal positioned in one sub-block, where the second pilot signal is a common pilot signal.

Further, the method further includes:
the second device transmits at least one of the following information to the first device:
pilot configuration information; and
precoding information corresponding to each sub-block.

Further, the pilot configuration information includes:
a position of the pilot signal in the first signal domain; and
a position of a second guard interval corresponding to the pilot signal in the first signal domain.

Further, after S1110, the method further includes:
the second device receives feedback information of precoding corresponding to a target sub-block from the first device, where the target sub-block is all or some sub-blocks of the N sub-blocks.

Further, the feedback information includes at least one of the following:
a quality of the precoding corresponding to the target sub-block;
a codeword for precoding recommended for the target sub-block; and
an MCS recommended for the target sub-block.

Further, the method further includes:
the second device transmits a pilot configuration scheme of the first signal to the first device.

Further, in a case that multiple antenna ports employ delay diversity transmission and/or Doppler diversity transmission, timing offset and/or frequency offset of the first device and a pilot signal corresponding to one antenna port have a quasi co-location.

Further, the quasi co-location is configured through at least one of the following methods:
indication through signaling; and
stipulation in a protocol.

The embodiment of the disclosure may implement the method embodiment in FIGS. 5-9, and realize the same technical effects, the repetition of which will not be described in detail herein.

It can be seen from the technical solution in the above embodiment that in the embodiment of the disclosure, the pilot signal is configured in the first signal, so that the first device may detect the first signal based on estimation through the pilot signal, and determine the quality information of the precoding corresponding to each sub-block. Therefore, the precoding of each sub-block may be dynamically adjusted through the feedback information, so that a more desirable match between the precoding and the actual channel is realized.

Based on the above embodiment, for example, after S1110, the method further includes:
the second device receives first information from the first device, where the first information includes channel information of a channel between the second device and the first device.

Further, the channel information includes at least one of the following:
Doppler information of the channel; and
delay information of the channel.

Further, the Doppler information of the channel includes at least one of the following:
all Doppler values of the channel; and
a Doppler maximum, a Doppler minimum, or a Doppler average of the channel.

Further, the delay information of the channel includes at least one of the following:
all delay values of the channel; and
a delay maximum, a delay minimum, or a delay average of the channel.

It can be seen from the technical solution in the above embodiment that in the embodiment of the disclosure, the delay values or a delay range, and the Doppler values or a Doppler range of the channel are directly described by newly defining various feedback quantities of the delay-Doppler domain in the first information fed back. Since the delay and Doppler of the channel encompass a law of channel transformation with time and a law of channel change with frequency, channel prediction may be better performed based on the feedback quantity newly added.

In the method for transmitting information according to the embodiment of the disclosure, an execution entity may be an apparatus for transmitting information. In the embodiment of the disclosure, the apparatus for transmitting information according to the embodiment of the disclosure is described with the apparatus for transmitting information executing the method for transmitting information as an example.

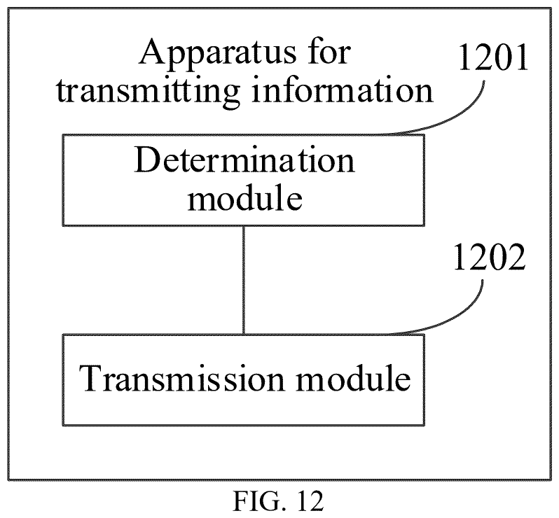

As shown in FIG. 12, the apparatus for transmitting information includes: a determination module 1201 and a transmission module 1202.

The determination module 1201 is configured to determine a first signal; and the transmission module 1202 is configured to transmit the first signal to a first device, where the first signal is acquired after a signal mapped on N sub-blocks of a first signal domain undergoes precoding corresponding to the sub-blocks, and then a precoded signal is transformed into a time-frequency domain; and the first signal domain is a delay-Doppler domain, the first signal domain is divided into the N sub-blocks, and N is a positive integer greater than or equal to 2.

Further, all ports on the same sub-block have the same number of layers.

Further, precoding is performed on all ports on the same sub-block with the same codeword.

Further, a codeword for the precoding is determined through one of the following methods:
stipulation in a protocol;
indication through signaling; and
selection from a codeword set for precoding.

Further, first guard intervals are configured between the N sub-blocks in a delay domain direction and a Doppler domain direction.

Further, precoding is performed on different sub-blocks having the same resource position in a delay domain and distinguished by first guard intervals in the Doppler domain direction with the same codeword.

Further, precoding is performed on different sub-blocks having the same resource position in a Doppler domain and distinguished by first guard intervals in the delay domain direction with the same codeword.

Further, the transmission module 1202 is further configured to transmit a sub-block division scheme of the first signal domain to the first device.

Further, the sub-block division scheme includes a resource identifier or a set of resource identifiers of the first signal domain.

It can be seen from the technical solution in the embodiment that in the embodiment of the disclosure, the delay-Doppler domain is divided into the N sub-blocks, and the precoding is performed on each sub-block with the corresponding codeword. Then, the first signal is transmitted after OTFS modulation is performed, so that a more desirable match between the precoding and an actual channel is realized.

Based on the above embodiment, for example, pilot signals are configured in at least some of the N sub-blocks of the first signal domain.

Further, the pilot signal in the first signal is at least one of the following:
a first pilot signal positioned in each sub-block; and
a second pilot signal positioned in one sub-block, where the second pilot signal is a common pilot signal.

Further, the transmission module 1202 is further configured to transmit at least one of the following information to the first device:
pilot configuration information; and
precoding information corresponding to each sub-block.

Further, the pilot configuration information includes:
a position of the pilot signal in the first signal domain; and
a position of a second guard interval corresponding to the pilot signal in the first signal domain.

Further, the transmission module 1202 is further configured to receive feedback information of precoding corresponding to a target sub-block from the first device, where the target sub-block is all or some sub-blocks of the N sub-blocks.

Further, the feedback information includes at least one of the following:
a quality of the precoding corresponding to the target sub-block;
a codeword for precoding recommended for the target sub-block; and
an MCS recommended for the target sub-block.

Further, the transmission module 1202 is further configured to transmit a pilot configuration scheme of the first signal to the first device.

Further, in a case that multiple antenna ports employ delay diversity transmission and/or Doppler diversity transmission, timing offset and/or frequency offset of the first device and a pilot signal corresponding to one antenna port have a quasi co-location.

Further, the quasi co-location is configured through at least one of the following methods:
indication through signaling; and
stipulation in a protocol.

It can be seen from the technical solution in the above embodiment that in the embodiment of the disclosure, the pilot signal is configured in the first signal, so that the first device may detect the first signal based on estimation through the pilot signal, and determine the quality information of the precoding corresponding to each sub-block. Therefore, the precoding of each sub-block may be dynamically adjusted through the feedback information, so that a more desirable match between the precoding and the actual channel is realized.

Based on the above embodiment, for example, the transmission module 1202 is further configured to receive first information from the first device, where the first information includes channel information of a channel between the second device and the first device.

Further, the channel information includes at least one of the following:
Doppler information of the channel; and
delay information of the channel.

Further, the Doppler information of the channel includes at least one of the following:
all Doppler values of the channel; and
a Doppler maximum, a Doppler minimum, or a Doppler average of the channel.

Further, the delay information of the channel includes at least one of the following:
all delay values of the channel; and
a delay maximum, a delay minimum, or a delay average of the channel.

It can be seen from the technical solution in the above embodiment that in the embodiment of the disclosure, the delay values or a delay range, and the Doppler values or a Doppler range of the channel are directly described by newly defining various feedback quantities of the delay-Doppler domain in the first information fed back. Since the delay and Doppler of the channel encompass a law of channel transformation with time and a law of channel change with frequency, channel prediction may be better performed based on the feedback quantity newly added.

The apparatus for transmitting information in the embodiment of the disclosure may be an electronic device, for example, an electronic device having an operating system, or a component in an electronic device, for example, an integrated circuit or a chip. The electronic device may be a terminal or another device except for the terminal. Illustratively, the terminal may be of, but is not limited to, a type of the terminal 11 listed above. Another device may be a server, a NAS, etc., which is not specifically limited in the embodiment of the disclosure.

The apparatus for transmitting information according to the embodiment of the disclosure may implement all processes implemented in the method embodiment in FIG. 11, and produces the same technical effects, which will not be described in detail herein to avoid repetition.

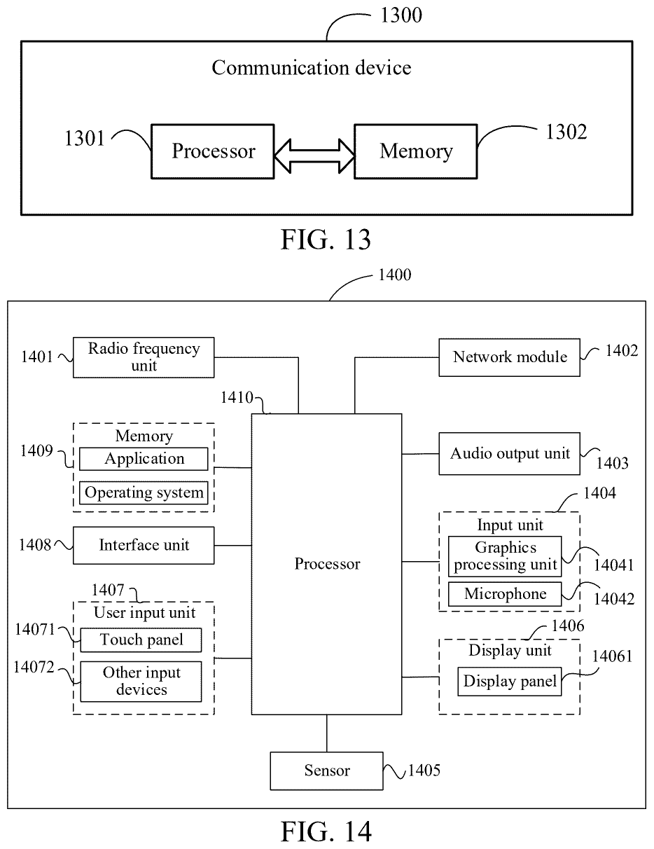

In an embodiment, as shown in FIG. 13, a communication device 1300 is further provided in an embodiment of the disclosure. The communication device includes a processor 1301 and a memory 1302, where the memory 1302 stores a program or instruction runnable on the processor 1301. For example, in a case that the communication device 1300 is a terminal, when executed by the processor 1301, the program or instruction implements all steps of the above method for transmitting information, and produces the same technical effects. In a case that the communication device 1300 is a network side device, when executed by the processor 1301, the program or instruction implements all steps in the above embodiment of the method for transmitting information, and produces the same technical effects, which is not described in detail herein to avoid repetition.

A terminal is further provided in an embodiment of the disclosure. The terminal includes a processor and a communication interface, where the processor is configured to parse a first signal, and the communication interface is configured to receive the first signal from a second device; and the first signal is acquired after a signal mapped on N sub-blocks of a first signal domain undergoes precoding corresponding to the sub-blocks, and then a precoded signal is transformed into a time-frequency domain. The terminal embodiment corresponds to the above terminal-side method embodiment. All implementation processes and implementations of the above method embodiment may be suitable for the terminal embodiment, and may produce the same technical effects. For example, FIG. 14 is a schematic structural diagram of hardware of a terminal according to an embodiment of the disclosure.

The terminal 1400 includes, but is not limited to, at least some of the following components: a radio frequency unit 1401, a network module 1402, an audio output unit 1403, an input unit 1404, a sensor 1405, a display unit 1406, a user input unit 1407, an interface unit 1408, a memory 1409, a processor 1410, etc.

Those skilled in the art can understand that the terminal 1400 may further include a power supply (such as a battery) for supplying power to all the components. The power supply may be logically connected to the processor 1410 through a power management system, thereby implementing functions such as charging, discharging, and power consumption management through the power management system. The terminal structure shown in FIG. 14 does not impose a limitation on the terminal. The terminal may include more or fewer components than those shown, combine some components, or have different component arrangements, which will not be described in detail herein.

It should be understood that in the embodiment of the disclosure, the input unit 1404 may include a Graphics Processing Unit (GPU) 14041 and a microphone 14042. The graphics processing unit 14041 processes image data of a static picture or a video that is obtained by an image capture apparatus (for example, a camera) in a video capture mode or an image capture mode. The display unit 1406 may include a display panel 14061. The display panel 14061 may be configured in a form of a liquid crystal display, an organic light-emitting diode, etc. The user input unit 1407 includes a touch panel 14071 and at least one of other input devices 14072. The touch panel 14071 or may be referred to as a touch screen. The touch panel 14071 may include a touch detection apparatus and a touch controller. Other input device 14072 may include, but are not limited to, a physical keyboard, a functional key (such as a volume control key or a switch key), a track ball, a mouse, and a joystick, which will not be described herein in detail.

In the embodiment of the disclosure, after receiving downlink data from a network side device, the radio frequency unit 1401 may transmit the downlink data to the processor 1410 for processing. In addition, the radio frequency unit 1401 may transmit uplink data to the network side device. Generally, the radio frequency unit 1401 includes, but is not limited to, an antenna, an amplifier, a transceiver, a coupler, a low-noise amplifier, a duplexer, etc.

The memory 1409 may be configured to store a software program or instruction and various data. The memory 1409 may primarily include a first storage area configured to store the program and instruction, and a second storage area configured to store the data, where the first storage area may store an operating system, an application or instruction required by at least one function (such as a sound playback function and an image display function), etc. In addition, the memory 1409 may include a volatile memory or a non-volatile memory. For example, the memory 1409 may include a volatile memory and a non-volatile memory. The non-volatile memory may be a Read-Only Memory (ROM), a Programmable ROM (PROM), an Erasable PROM (EPROM), an Electrically EPROM (EEPROM), or a flash memory. The volatile memory may be a Random Access Memory (RAM), a Static RAM (SRAM), a Dynamic RAM (DRAM), a Synchronous DRAM (SDRAM), a Double Data Rate SDRAM (DDRSDRAM), an Enhanced SDRAM (ESDRAM), a Synchronous Link DRAM (SLDRAM), and a Direct Rambus RAM (DRRAM). The memory 1409 in the embodiment of the disclosure includes, but is not limited to, these memories and any other suitable types of memories.

The processor 1410 may include one or more processing units. In an embodiment, the processor 1410 integrates an application processor and a modem processor, where the application processor primarily processes operations involving an operating system, a user interface, an application, etc., and the modem processor primarily processes a radio communication signal, and may be a baseband processor, for example. It can be understood that the above modem processor may not be integrated into the processor 1410.

The radio frequency unit 1401 is configured to receive a first signal from a second device, where the first signal is acquired after a signal mapped on N sub-blocks of a first signal domain undergoes precoding corresponding to the sub-blocks, and then a precoded signal is transformed into a time-frequency domain; and
the processor 1410 is configured to parse the first signal; where
the first signal domain is a delay-Doppler domain, the first signal domain is divided into the N sub-blocks, and N is a positive integer greater than or equal to 2.

Further, all ports on the same sub-block have the same number of layers.

Further, precoding is performed on all ports on the same sub-block with the same codeword.

Further, a codeword for the precoding is determined through one of the following methods:
stipulation in a protocol;
indication through signaling; and
selection from a codeword set for precoding.

Further, first guard intervals are configured between the N sub-blocks in a delay domain direction and a Doppler domain direction.

Further, precoding is performed on different sub-blocks having the same resource position in a delay domain and distinguished by first guard intervals in the Doppler domain direction with the same codeword.

Further, precoding is performed on different sub-blocks having the same resource position in a Doppler domain and distinguished by first guard intervals in the delay domain direction with the same codeword.

Further, the radio frequency unit 1401 is further configured to acquire a sub-block division scheme of the first signal domain.

Further, the sub-block division scheme includes a resource identifier or a set of resource identifiers of the first signal domain.

Further, the sub-block division scheme is acquired through at least one of the following methods:
acquisition from the second device; and
stipulation in a protocol.

In the embodiment of the disclosure, a better match between the precoding and an actual channel is realized.

Based on the above embodiment, for example, the processor 1410 is further configured to detect the first signal, and determine quality information of the precoding corresponding to the N sub-blocks.

Further, the processor 1410 is configured to:
determine a pilot signal in the first signal according to pilot configuration information, and acquire first channel information corresponding to the pilot signal; where the first channel information is equivalent channel information acquired based on spatial channel information and precoding information; and
the processor detects the first signal according to the first channel information, and determines the quality information of the precoding corresponding to the N sub-blocks.

Further, the pilot signal in the first signal is at least one of the following:
a first pilot signal positioned in each sub-block; and
a second pilot signal positioned in one sub-block, where the second pilot signal is a common pilot signal.

Further, for the first pilot signal, the processor 1410 is configured to:
determine a position of the first pilot signal in each sub-block in the first signal and a position of a second guard interval corresponding to the first pilot signal according to the pilot configuration information; and
acquire first channel information of each sub-block according to the position of the first pilot signal in each sub-block and the position of the second guard interval corresponding to the first pilot signal.

Further, for the second pilot signal, the processor 1410 is configured to:
determine a position of the second pilot signal in the first signal and a position of a second guard interval corresponding to the second pilot signal according to the pilot configuration information; and
acquire first channel information corresponding to the second pilot signal according to the position of the second pilot signal and the position of the second guard interval corresponding to the second pilot signal.

Further, the processor 1410 is configured to:
acquire first channel information of a sub-block in which the second pilot signal is positioned according to the position of the second pilot signal and the position of the second guard interval corresponding to the second pilot signal;
acquire second channel information corresponding to the second pilot signal according to the first channel information of the sub-block in which the second pilot signal is positioned and the precoding information; where the second channel information is spatial channel information; and
acquire first channel information of each sub-block according to precoding information and the second channel information of each sub-block.

Further, the pilot configuration information includes:
a position of the pilot signal in the first signal domain; and
a position of a second guard interval corresponding to the pilot signal in the first signal domain.

Further, the radio frequency unit 1401 is further configured to acquire at least one of the following information:
pilot configuration information; and
precoding information corresponding to each sub-block.

Further, the pilot configuration information and/or the precoding information corresponding to each sub-block are/is acquired through at least one of the following methods:
acquisition from the second device; and
stipulation in a protocol.

Further, the radio frequency unit 1401 is further configured to feed back feedback information of precoding corresponding to a target sub-block to the second device, where the target sub-block is all or some sub-blocks of the N sub-blocks.

Further, the feedback information includes at least one of the following:
a quality of the precoding corresponding to the target sub-block;
a codeword for precoding recommended for the target sub-block; and
an MCS recommended for the target sub-block.

Further, the radio frequency unit 1401 is further configured to acquire a pilot configuration scheme of the first signal.

Further, the pilot configuration scheme is acquired through at least one of the following methods:
acquisition from the second device; and
stipulation in a protocol.

Further, in a case that multiple antenna ports employ delay diversity transmission and/or Doppler diversity transmission, timing offset and/or frequency offset of the first device and a pilot signal corresponding to one antenna port have a quasi co-location.

Further, the quasi co-location is configured through at least one of the following methods:
indication through signaling; and
stipulation in a protocol.

In the embodiment of the disclosure, the precoding of each sub-block may be dynamically adjusted through the feedback information, so that a more desirable match between the precoding and the actual channel is realized.

Based on the above embodiment, for example, the radio frequency unit 1401 is further configured to transmit first information to the second device, where the first information includes channel information of a channel between the first device and the second device.

Further, the channel information includes at least one of the following:
Doppler information of the channel; and
delay information of the channel.

Further, the Doppler information of the channel includes at least one of the following:
all Doppler values of the channel; and
a Doppler maximum, a Doppler minimum, or a Doppler average of the channel.

Further, the delay information of the channel includes at least one of the following:
all delay values of the channel; and
a delay maximum, a delay minimum, or a delay average of the channel.

In the embodiment of the disclosure, channel prediction can be better performed.

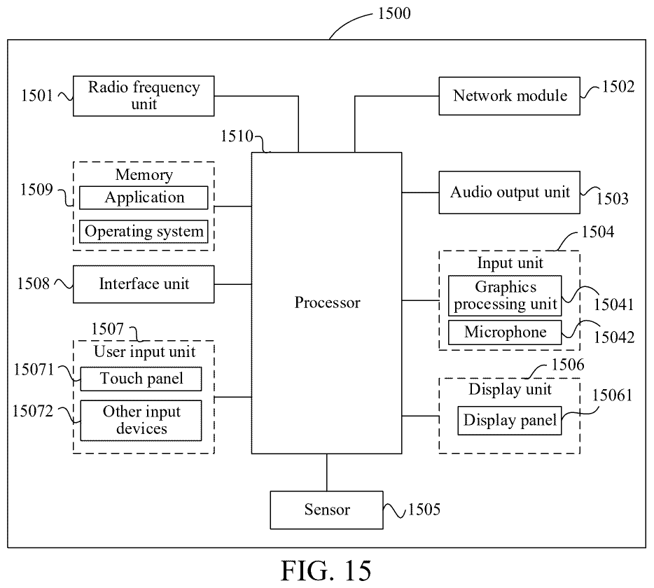

A terminal is further provided in an embodiment of the disclosure. The terminal includes a processor and a communication interface, where the processor is configured to determine a first signal, and the communication interface is configured to transmit the first signal to a first device; and the first signal is acquired after a signal mapped on N sub-blocks of a first signal domain undergoes precoding corresponding to the sub-blocks, and then a precoded signal is transformed into a time-frequency domain. The terminal embodiment corresponds to the above terminal-side method embodiment. All implementation processes and implementations of the above method embodiment may be suitable for the terminal embodiment, and may produce the same technical effects. For example, FIG. 15 is a schematic structural diagram of hardware of a terminal according to an embodiment of the disclosure.

The terminal 1500 includes, but is not limited to, at least some of the following components: a radio frequency unit 1501, a network module 1502, an audio output unit 1503, an input unit 1504, a sensor 1505, a display unit 1506, a user input unit 1507, an interface unit 1508, a memory 1509, a processor 1510, etc.

Those skilled in the art can understand that the terminal 1500 may further include a power supply (such as a battery) for supplying power to all the components. The power supply may be logically connected to the processor 1510 through a power management system, thereby implementing functions such as charging, discharging, and power consumption management through the power management system. The terminal structure shown in FIG. 15 does not impose a limitation on the terminal. The terminal may include more or fewer components than those shown, combine some components, or have different component arrangements, which will not be described in detail herein.

It should be understood that in the embodiment of the disclosure, the input unit 1504 may include a Graphics Processing Unit (GPU) 15041 and a microphone 15042. The graphics processing unit 15041 processes image data of a static picture or a video that is obtained by an image capture apparatus (for example, a camera) in a video capture mode or an image capture mode. The display unit 1506 may include a display panel 15061. The display panel 15061 may be configured in a form of a liquid crystal display, an organic light-emitting diode, etc. The user input unit 1507 includes a touch panel 15071 and at least one of other input devices 15072. The touch panel 15071 or may be referred to as a touch screen. The touch panel 15071 may include a touch detection apparatus and a touch controller. Other input device 15072 may include, but are not limited to, a physical keyboard, a functional key (such as a volume control key or a switch key), a track ball, a mouse, and a joystick, which will not be described herein in detail.

In the embodiment of the disclosure, after receiving downlink data from a network side device, the radio frequency unit 1501 may transmit the downlink data to the processor 1510 for processing. In addition, the radio frequency unit 1501 may transmit uplink data to the network side device. Generally, the radio frequency unit 1501 includes, but is not limited to, an antenna, an amplifier, a transceiver, a coupler, a low-noise amplifier, a duplexer, etc.

The memory 1509 may be configured to store a software program or instruction and various data. The memory 1509 may primarily include a first storage area configured to store the program and instruction, and a second storage area configured to store the data, where the first storage area may store an operating system, an application or instruction required by at least one function (such as a sound playback function and an image display function), etc. In addition, the memory 1509 may include a volatile memory or a non-volatile memory. For example, the memory 1509 may include a volatile memory and a non-volatile memory. The non-volatile memory may be a ROM, a PROM, an EPROM, an EEPROM, or a flash memory. The volatile memory may be a RAM, a SRAM, a DRAM, a SDRAM, a DDRSDRAM, an ESDRAM, a SLDRAM, and a DRRAM. The memory 1509 in the embodiment of the disclosure includes, but is not limited to, these memories and any other suitable types of memories.

The processor 1510 may include one or more processing units. In an embodiment, the processor 1510 integrates an application processor and a modem processor, where the application processor primarily processes operations involving an operating system, a user interface, an application, etc., and the modem processor primarily processes a radio communication signal, and may be a baseband processor, for example. It can be understood that the above modem processor may not be integrated into the processor 1510.

The processor 1510 is configured to determine a first signal; and

the radio frequency unit 1501 is configured to transmit the first signal to a first device, where the first signal is acquired after a signal mapped on N sub-blocks of a first signal domain undergoes precoding corresponding to the sub-blocks, and then a precoded signal is transformed into a time-frequency domain; and the first signal domain is a delay-Doppler domain, the first signal domain is divided into the N sub-blocks, and N is a positive integer greater than or equal to 2.

Further, all ports on the same sub-block have the same number of layers.

Further, precoding is performed on all ports on the same sub-block with the same codeword.

Further, a codeword for the precoding is determined through one of the following methods:
stipulation in a protocol;
indication through signaling; and
selection from a codeword set for precoding.

Further, first guard intervals are configured between the N sub-blocks in a delay domain direction and a Doppler domain direction.

Further, precoding is performed on different sub-blocks having the same resource position in a delay domain and distinguished by first guard intervals in the Doppler domain direction with the same codeword.

Further, precoding is performed on different sub-blocks having the same resource position in a Doppler domain and distinguished by first guard intervals in the delay domain direction with the same codeword.

Further, the radio frequency unit 1501 is further configured to transmit a sub-block division scheme of the first signal domain to the first device.

Further, the sub-block division scheme includes a resource identifier or a set of resource identifiers of the first signal domain.

In the embodiment of the disclosure, a better match between the precoding and an actual channel is realized.

Based on the above embodiment, for example, pilot signals are configured in at least some of the N sub-blocks of the first signal domain.

Further, the pilot signal in the first signal is at least one of the following:
a first pilot signal positioned in each sub-block; and
a second pilot signal positioned in one sub-block, where the second pilot signal is a common pilot signal.

Further, the radio frequency unit 1501 is further configured to transmit at least one of the following information to the first device:
pilot configuration information; and
precoding information corresponding to each sub-block.

Further, the pilot configuration information includes:
a position of the pilot signal in the first signal domain; and
a position of a second guard interval corresponding to the pilot signal in the first signal domain.

Further, the radio frequency unit 1501 is further configured to receive feedback information of precoding corresponding to a target sub-block from the first device, where the target sub-block is all or some sub-blocks of the N sub-blocks.

Further, the feedback information includes at least one of the following:
a quality of the precoding corresponding to the target sub-block;
a codeword for precoding recommended for the target sub-block; and
an MCS recommended for the target sub-block.

Further, the radio frequency unit 1501 is further configured to transmit a pilot configuration scheme of the first signal to the first device.

Further, in a case that multiple antenna ports employ delay diversity transmission and/or Doppler diversity transmission, timing offset and/or frequency offset of the first device and a pilot signal corresponding to one antenna port have a quasi co-location.

Further, the quasi co-location is configured through at least one of the following methods:
indication through signaling; and
stipulation in a protocol.

It can be seen from the technical solution in the above embodiment that in the embodiment of the disclosure, the pilot signal is configured in the first signal, so that the first device may detect the first signal based on estimation through the pilot signal, and determine the quality information of the precoding corresponding to each sub-block. Therefore, the precoding of each sub-block may be dynamically adjusted through the feedback information, so that a more desirable match between the precoding and the actual channel is realized.

Based on the above embodiment, for example, the radio frequency unit 1501 is further configured to receive first information from the first device, where the first information includes channel information of a channel between the second device and the first device.

Further, the channel information includes at least one of the following:
Doppler information of the channel; and
delay information of the channel.

Further, the Doppler information of the channel includes at least one of the following:
all Doppler values of the channel; and
a Doppler maximum, a Doppler minimum, or a Doppler average of the channel.

Further, the delay information of the channel includes at least one of the following: all delay values of the channel; and
a delay maximum, a delay minimum, or a delay average of the channel.

In the embodiment of the disclosure, channel prediction can be better performed.

A network side device is further provided in an embodiment of the disclosure. The network side device includes a processor and a communication interface, where the processor is configured to parse a first signal, and the communication interface is configured to receive the first signal from a second device; and the first signal is acquired after a signal mapped on N sub-blocks of a first signal domain undergoes precoding corresponding to the sub-blocks, and then a precoded signal is transformed into a time-frequency domain. The network side device embodiment corresponds to the above network side device method embodiment. All implementation processes and implementations of the above method embodiment may be suitable for the network side device embodiment, and may produce the same technical effects.

Another network side device is further provided in an embodiment of the disclosure. The network side device includes a processor and a communication interface, where the processor is configured to determine a first signal, and the communication interface is configured to transmit the first signal to a first device; and the first signal is acquired after a signal mapped on N sub-blocks of a first signal domain undergoes precoding corresponding to the sub-blocks, and then a precoded signal is transformed into a time-frequency domain. The network side device embodiment corresponds to the above network side device method embodiment. All implementation processes and implementations of the above method embodiment may be suitable for the network side device embodiment, and may produce the same technical effects.

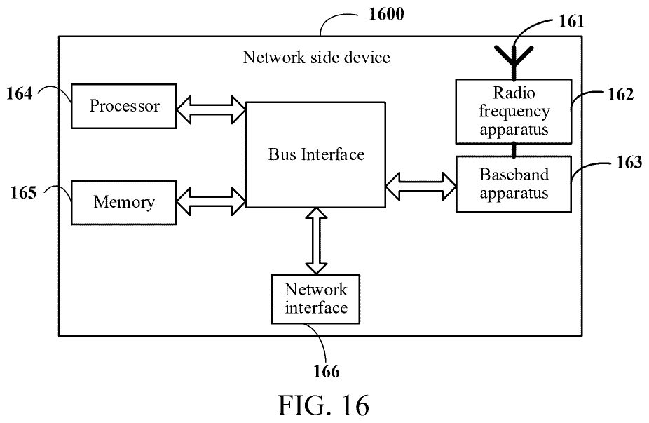

For example, a network side device is further provided in an embodiment of the disclosure. As shown in FIG. 16, the network side device 1600 includes: an antenna 161, a radio frequency apparatus 162, a baseband apparatus 163, a processor 164, and a memory 165. The antenna 161 is connected to the radio frequency apparatus 162. In an uplink direction, the radio frequency apparatus 162 receives information via the antenna 161, and transmits the information received to the baseband apparatus 163 for processing. In a downlink direction, the baseband apparatus 163 processes the information to be transmitted, and transmits processed information to the radio frequency apparatus 162. The radio frequency apparatus 162 processes information received, and transmits processed information via the antenna 161.

The method executed by the network side device in the above embodiment may be implemented in the baseband apparatus 163. The baseband apparatus 163 includes a baseband processor.

For example, the baseband apparatus 163 may include at least one baseband board, and multiple chips are arranged on the baseband board. As shown in FIG. 16, one chip, for example, the baseband processor, is connected to the memory 165 through a bus interface, so as to invoke a program in the memory 165 for executing network device operations shown in the above method embodiment.

The network side device may further include a network interface 166. The interface is, for example, a common public radio interface (common public radio interface, CPRI).

For example, the network side device 1600 in the embodiment of the disclosure further includes: an instruction or program stored in the memory 165 and runnable on the processor 164, where the processor 164 invokes the instruction or program in the memory 165 to execute the method executed by all the modules shown in FIG. 10 or 12, and produce the same technical effects, which will not be described in detail herein to avoid repetition.

A readable storage medium is further provided in an embodiment of the disclosure. The readable storage medium stores a program or instruction, where when executed by a processor, the program or instruction implements all processes in the above embodiment of the method for transmitting information, and produces the same technical effects, which will not be described herein to avoid repetition.

The processor is the processor in the terminal in the above embodiment. The readable storage medium includes a computer-readable storage medium, such as a computer ROM, a RAM, a magnetic disk, and an optical disc.

A chip is further provided in an embodiment of the disclosure. The chip includes a processor and a communication interface, where the communication interface is coupled to the processor, and the processor is configured to run a program or instruction, so as to implement all processes in the above embodiment of the method for transmitting information, and produce the same technical effects, which will not be described in detail herein to avoid repetition.

It should be understood that the chip mentioned in the embodiment of the disclosure or may be referred to as a system-level chip, a system chip, a chip system, a chip on a system on chip, etc.

A computer program/program product is further provided in an embodiment of the disclosure. The computer program/program product is stored in a storage medium, and the computer program/program product is executed by at least one processor, so as to implement all processes in the above embodiment of the method for transmitting information, and produce the same technical effects, which will not be described in detail herein to avoid repetition.

A system for transmitting information is further provided in an embodiment of the disclosure. The system includes: a terminal and a network side device, where the terminal may be configured to execute steps of the above method for transmitting information, and the network side device may be configured to execute steps of the above method for transmitting information.

It should be noted that the terms “include”, “comprise”, “encompass”, or their any other variations herein are intended to cover non-exclusive inclusions. Therefore, a process, method, article, or apparatus including a series of elements further includes other elements not explicitly listed or elements inherent to such a process, method, article, or apparatus, except for those elements. Without more limitations, an element defined by the phrases “comprise a . . . ” and “include a . . . ” does not exclude that other identical elements still exist in the process, method, article, or apparatus including the element. In addition, it should be noted that the scope of the method and apparatus in the implementations of the disclosure is not limited to executing functions in an order shown or discussed, and may further include executing functions in a substantially simultaneous manner or in a reverse order according to the functions involved. For example, the methods described may be executed in an order different from the order described, and various steps may be added, omitted, or combined. In addition, features described with reference to some examples may be combined in other examples.

Through the descriptions in the above implementations, those skilled in the art can clearly understand that the method in the above embodiment can be implemented by means of software and a necessary general hardware platform, and can also be implemented by means of hardware. In many cases, the former is a better implementation. Based on such understanding, the technical solutions of the disclosure in nature or the part contributing to the related art can be implemented in a form of a computer software product. The computer software product is stored in one storage medium (for example, the ROM/RAM, the magnetic disk, and the optical disc), and includes several instructions configured to cause one terminal (which may be a mobile phone, a computer, a server, an air conditioner, or a network device, etc.) to execute the method in each embodiment of the disclosure.

The embodiments of the disclosure have been described above with reference to the accompanying drawings. However, the disclosure is not limited to the above particular implementations, and the above particular implementations are merely illustrative, but are not restrictive. Those of ordinary skill in the art can also make various forms under the teaching of the disclosure without departing from the spirit of the disclosure and the scope of protection of the claims, and such variations fall within the scope of protection of the disclosure.

What is claimed is:

1. A method for transmitting information, comprising:
transmitting, by a second device, a first signal to a first device,
wherein the first signal is generated precoding a signal mapped on N sub-blocks of a first signal domain corresponding to the sub-blocks, and then transforming the precoded signal into a time-frequency domain, wherein the first signal domain is a delay-Doppler domain, the first signal domain is divided into the N sub-blocks, and N is a positive integer greater than or equal to 2.

2. The method according to claim 1, wherein all ports on a same sub-block have a same number of layers.

3. The method according to claim 1, wherein the precoding is performed on all ports on a same sub-block with a same codeword.

4. The method according to claim 1, wherein a codeword for the precoding is determined through one of the following methods:
stipulation in a protocol;
indication through signaling; or
selection from a codeword set for precoding.

5. The method according to claim 1, wherein first guard intervals are configured between the N sub-blocks in a delay domain direction and a Doppler domain direction.

6. The method according to claim 1, wherein pilot signals are configured in at least some of the N sub-blocks of the first signal domain.

7. The method according to claim 1, further comprising:
transmitting, by the second device, at least one of the following information to the first device:
pilot configuration information; and
precoding information corresponding to each sub-block.

8. The method according to claim 1, wherein after the transmitting, by the second device, the first signal to a first device, the method further comprises:
receiving, by the second device, feedback information of precoding corresponding to a target sub-block from the first device, wherein the target sub-block is all or some of the N sub-blocks.

9. The method according to claim 1, further comprising:
transmitting, by the second device, a sub-block division scheme of the first signal domain to the first device.

10. The method according to claim 1, wherein after the transmitting, by the second device, the first signal to the first device, the method further comprises:
receiving, by the second device, first information from the first device, wherein the first information comprises channel information of a channel between the second device and the first device.

11. A method for transmitting information, comprising:
receiving, by a first device, a first signal from a second device,
wherein the first signal is generated precoding a signal mapped on N sub-blocks of a first signal domain corresponding to the sub-blocks, and then transforming the precoded signal into a time-frequency domain, wherein the first signal domain is a delay-Doppler domain, the first signal domain is divided into the N sub-blocks, and N is a positive integer greater than or equal to 2.

12. The method according to claim 11, wherein after the receiving, by the first device, the first signal from a second device, the method further comprises:
detecting, by the first device, the first signal, and determining quality information of the precoding corresponding to the N sub-blocks.

13. The method according to claim 11, wherein all ports on a same sub-block have a same number of layers.

14. The method according to claim 11, wherein the precoding is performed on all ports on a same sub-block with a same codeword.

15. The method according to claim 11, wherein a codeword for the precoding is determined through one of the following methods:
stipulation in a protocol;
indication through signaling; or
selection from a codeword set for precoding.

16. The method according to claim 12, wherein the detecting, by the first device, the first signal, and determining quality information of the precoding corresponding to the N sub-blocks comprise:
determining, by the first device, a pilot signal in the first signal according to pilot configuration information, and acquiring first channel information corresponding to the pilot signal,
wherein the first channel information is equivalent channel information acquired based on spatial channel information and precoding information; and detecting the first signal according to the first channel information, and determining the quality information of the precoding corresponding to the N sub-blocks.

17. The method according to claim 16, wherein the pilot signal in the first signal is at least one of the following:
a first pilot signal positioned in each sub-block; or
a second pilot signal positioned in one sub-block, wherein the second pilot signal is a common pilot signal.

18. The method according to claim 12, wherein before the detecting, by the first device, the first signal, and determining quality information of the precoding corresponding to the N sub-blocks, the method further comprises:
acquiring, by the first device, at least one of the following information:
pilot configuration information; and
precoding information corresponding to each sub-block.

19. The method according to claim 12, wherein after the detecting, by the first device, the first signal, and determining quality information of the precoding corresponding to the N sub-blocks, the method further comprises:
feeding back, by the first device, feedback information of precoding corresponding to a target sub-block to the second device, wherein the target sub-block is all or some of the N sub-blocks.

20. A terminal, comprising a processor and a memory storing instructions, wherein the instructions, when executed by the processor, cause the processor to perform operations comprising:
transmitting a first signal to a first device, wherein the first signal is generated precoding a signal mapped on N sub-blocks of a first signal domain corresponding to the sub-blocks, and then transforming the precoded signal into a time-frequency domain, wherein the first signal domain is a delay-Doppler domain, the first signal domain is divided into the N sub-blocks, and N is a positive integer greater than or equal to 2.
